(19) United States
(12) Patent Application Publication
(10) Pub. No.: US 2002/0126070 A1
(43) Pub. Date: Sep. 12, 2002

(54) Sub- field driven display device and method

(76) Inventors: Antonius Hendricus Maria Holtslag, Eindhoven (NL); Roy Van Dijk, Eindhoven (NL)

Correspondence Address: Michael E. Marion, U.S. Philips Corporation, 580 White Plains Road, Tarrytown, NY, 10591, US

(21) Appl. No.: 10/043,384

(22) Filed: Oct. 26, 2001

(30) Foreign Application Priority Data
Oct. 31, 2000 (EP) 00203787.7

(51) Int. Cl. G09G 3/28

(52) U.S. Cl. 345/60

(57) ABSTRACT

The present invention provides for a sub-field driven display device and related method wherein sub-fields are weighted and duplicated for achieving a plurality of grey levels by way of a plurality of sub-fields, and in which the sub-fields are weighted as a ternary distribution of sub-field weights.

The present invention relates to a sub-field driven display device and method wherein sub-fields are weighted and duplicated for providing a plurality of grey levels by way of a plurality of sub-fields.

Such a sub-field driven display and method are known from EP-A-0 896 317 which discloses a colour image display device wherein colour video signals are supplied to red, green and blue light-emitting cells, for example, the cells of a plasma display device. The device employs the known sub-field method of displaying the required grey scale representation by controlling the light-emitting luminous levels of the respective red, green and blue light-emitting cells. In this known sub-field method, one display field is divided into a plurality of sub-fields on a time base and light-emitting weights are allotted to the respective sub-fields, and light emission in each of the respective sub-fields is then either controlled in an on/off manner so as to provide the appropriate grey level gradation. The required gradation is commonly provided by employing a binary ratio weighting for the sub-fields.

Performance can be disadvantageously limited with such known display devices and methods and the present invention seeks to provide for a sub-field driven display device and method offering improved performance. In particular the present invention seeks to provide improved performance through the identification of particular limitations, and related problems, as found in the prior art and which are identified in accordance with the present invention and arise particularly in view of the number of sub-fields employed, which serves to disadvantageously limit the performance of known devices and methods due to motion artefacts and the limited number of grey levels available.

The present invention further seeks to provide for an improved sub-field driven display device and method which readily allows for the adoption of duplicated sub-field addressing.

According to one aspect of the present invention, there is provided a sub-field driven display device of the type defined above, characterized in that the sub-fields are weighted in accordance with a ternary distribution of sub-field weights.

As will be illustrated further within the present application, the adoption of a ternary distribution of weights advantageously optimizes the ratio of grey levels to sub-fields adopted such that, when compared with known weighting distributions, and for a given number of sub-fields, the present invention advantageously allows for an increased number of grey levels, thereby advantageously enhancing the performance of sub-field driven display devices. Stated in the alternative, the invention therefore has the advantage that, with a minimal number of sub-fields, the highest maximum value of grey level can be achieved while still retaining the possibility of also producing all intermediate grey level values.

The feature defined in claim 2 is particularly advantageous in readily allowing for the application of a duplicated sub-field addressing method which, in turn, advantageously reduces motion artefact problems that can be apparent in such devices.

The feature of claim 3 further facilitates such advantages and the feature defined in claim 4 has the advantage that, with the heaviest weighting value found within the middle of the sub-field weighting distribution, this central sub-field position can advantageously act as a reference time value for motion compensation.

The features defined in claims 5 to 8 relate to corresponding method steps for the present invention and exhibit advantages similar to those discussed above.

The feature defined in claim 9 specifically introduces the adoption of a duplicated sub-field addressing method which can readily be achieved in accordance with the sub-field distribution arising in the present invention. Such an addressing method allows for motion artefact reduction, even without use of a motion estimator, and even though the method, if required, can be combined with motion compensation based on motion estimation.

The present invention is described further hereinafter by way of example only, with reference to the accompanying drawings in which:

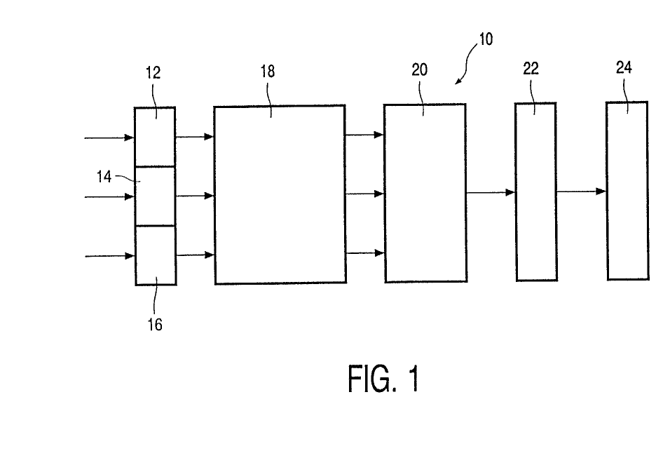

FIG. 1 represents a block diagram of a display device embodying the present invention; and

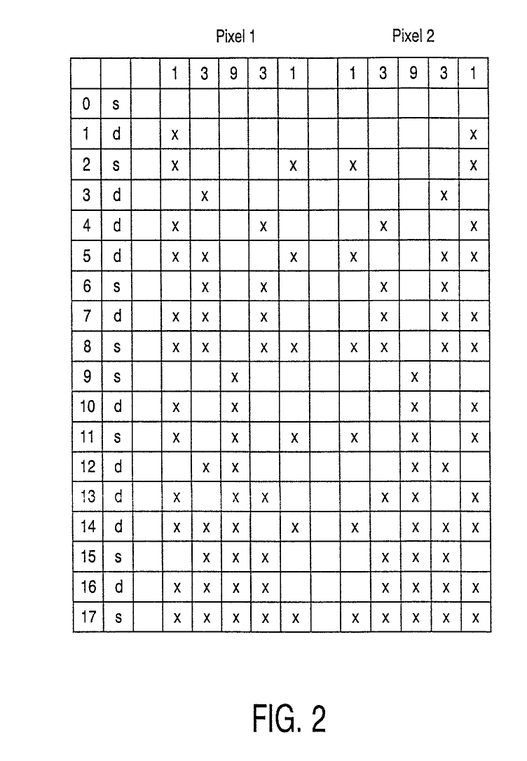

FIG. 2 comprises a tabular representation grey level production for two pixels in accordance with an embodiment of the present invention.

It should be appreciated that the present invention can readily employ the techniques for weighting and distributing duplicated sub fields as disclosed in EP-A-0 899 710, EP-A-0 698 874 and EP-A-0 896 317.

As will be appreciated, the present invention relates to the adoption of a ternary weighting distribution for a sub-field driven display device and related method in which, as will be illustrated below, specific advantages leading to an improved performance in display devices can be achieved.

For example, the ternary distribution:

1,3,9,27,9,3,1

represents a particularly advantageous weighting in accordance with the present invention since the ternary distribution is not only a symmetrical distribution but also offers its maximum value at the centre of the distribution.

As will be appreciated, through the effective use of seven sub-fields—each—employing a respective one of the weightings noted above all integer values of grey level between 0 and the maximum possible grey level, 53 in this example, can be realised. When compared, for example, with a binary distribution as known in the prior art, a greater number of sub-fields will be required in order to arrive at a similar number of grey level values. This is particularly true for symmetrical series.

The ternary distribution has associated advantages in that it readily allows for particularly effective motion artifact reduction through the application of the known duplicated sub-field addressing method which, if required, can be combined with motion compensation based on motion estimation.

As noted in the above example, it is particularly advantageous to provide for the heaviest weighting value in the centre of the sub-field weighting distribution since this sub-field position can then readily act as a reference time t=0, for motion compensation. This can be preferred since the maximum amount of light is generated within the middle of the sub-field distribution and is not liable to be effected by any possible truncation error. The lower weights, i.e. the weighting values of the sub-fields on either side of the central heaviest weight, are then effectively duplicated on either side of the central weight and turned on in accordance with the example of two driven pixels as illustrated in the accompanying drawing.

Turning now to FIG. 1, there is illustrated in block-diagrammatic form one embodiment of a display device 10 according to the present invention. The device 10 includes analog/digital converters 12, 14, 16 for each of the incoming analog Red, Green and Blue video signals, which converters subsequently supply the digital video signals to a sub-field converter 18. The signals output from the sub-field converter 18 are received by a sub-field sequence converter 20 including a frame memory which in turn supplies the sub-field divided signal to a display driver 22. The driver 22 is arranged to provide drive signals to the display such as a plasma display panel 24.

Referring now to the drawing, shown in FIG. 2, each of the possible 18 grey levels is identified down the left-hand column whereas the ternary weighting for each of the 5 sub-fields of each of pixels 1 and 2 is illustrated across the top row of the table and confirms that the ternary distribution 1,3,9,3,1 is employed for illustrative purposes within this embodiment of the present invention. The distribution of crosses within the table indicates which of the weighted sub-fields is driven in order to provide the particular grey scale level indicated in the left-hand column.

In further detail, consideration can be given to the distribution of (2n+1) values aᵢ:

a₀, a₁, a₂, a₃, . . . , aₙ₋₁, aₙ, aₙ₋₁, . . . , a₃, a₂, a₁, a₀, while a₀=1

With a number of grey levels, G₂ₙ₊₁, equal to (note: consider also the grey value 0):

$${G}_{2 n + 1} = 1 + {a}_{n} + 2 {\sum }_{0}^{n - 1} {a}_{i}$$

The symmetrical distribution is constructed in order to apply the distributed sub-field method. The values aₙ are integer values, such that all values from 0 to G₂ₙ₊₁ can be realised.

The heaviest weights will preferably be in the middle of the distribution, while the smaller values are located further away from the middle; therefore a₀=1.

A distribution for n=4 is advantageously constructed as follows:

| a₀ | a₁ | a₂ | a₃ | a₄ | a₃ | a₂ | A₁ | a₀ | Construction comment: |
|---|---|---|---|---|---|---|---|---|---|
| 1 | . . . | . . . | . . . | . . . | . . . | . . . | . . . | 1 | sum 2, so take 3 as next |
| | | | | | | | | | DSF number |
| 1 | 3 | . . . | . . . | . . . | . . . | . . . | 3 | 1 | sum 8, so take 9 as next |
| | | | | | | | | | DSF number |
| 1 | 3 | 9 | . . . | . . . | . . . | 9 | 3 | 1 | sum 26, so take 27 as next |
| | | | | | | | | | DSF number |
| 1 | 3 | 9 | 27 | 81 | 27 | 9 | 3 | 1 | sum 80, finalise with 81 in |
| | | | | | | | | | the middle |

Thus all integer values between 0 and a maximum grey level of 161 can be produced giving G₉=162 grey levels.

In general: aₙ=3ⁿ, n=0, 1, 2, 3 . . . ,

Giving: 2n+1 sub-fields,

While: G₂ₙ₊₁=2.3ⁿ.

This provides for a ternary series.

For a symmetrical binary series of (2n+1) sub-fields, with the highest weight in the middle, the number of grey levels equals G₂ₙ₊₁=2.2ⁿ, which is a factor (3/2)ₙ less. At (2n+1)=9 sub-fields (thus n=4), this differs a factor 5.0625 (5). This clearly illustrates how, for a given number of sub-fields the device and method of the present invention can provide for an optimum number of grey scale values.

At an even number of sub-fields, one additional term is generally to be determined. To keep the distribution fully symmetrical, the heaviest weight can be copied, or repeated, in the middle as follows:

a₀, a₁, a₂, a₃, . . . , aₙ₋₁, aₙ, aₙ, aₙ₋₁, . . . , a₃, a₂, a₁, a₀, while a₀=1

example for n=3: 1,3,9,27,27,9,3,1, G₈=81.

Alternatively, a series can be developed in which the term ao is not duplicated. Using the same values as above, this arrives at:

1,2,6,18,54,18,6,2

which for the same number of eight sub-fields gives 108 grey levels.

As will be appreciated, the maximum possible number of grey levels is advantageously achieved in accordance with the present invention while, if required, for the highest of all possible weights, a symmetrical value can also be adopted. When also applying the duplicate sub-field method so as to achieve motion compensation, the pixels identified as A pixel and B pixel in the duplicated sub-field method can advantageously be addressed by one of the symmetrical options.

It should of course be appreciated that the present invention can be used in all displays which employ sub-field distributions and include, but are not limited to, Plasma Display Panels, Digital Mirror Devices and Dynamic Foil Displays.

Also the invention is not restricted to the details of the foregoing embodiment since, for example, an asymmetrical ternary distribution, and without having the highest weighted value centrally located, could still nevertheless advantageously be employed so as to arrive at advantages offered by the present invention.

1. A sub-field driven display device (10) having a sub-field converter (18) for converting video signals into sub-field data in which the sub-fields are weighted and duplicated for achieving a plurality of grey levels by way of a plurality of sub-fields, characterized in that the sub-field converter (18) is arranged to weight the sub-fields as a ternary distribution of sub-field weights.

2. A display device (10) as claimed in claim 1, wherein the sub-field converter (18) is arranged to employ symmetrical duplicated ternary weights.

3. A display device (10) as claimed in claim 1 or 2, wherein the sub-field converter (18) is arranged to distribute the ternary weights in a manner of increasing weighted value toward a central value or values.

4. A display device (10) as claimed in claim 1, 2 or 3, wherein the sub-field converter (18) is arranged to provide the highest sub-field weight at the centre of the ternary distribution.

5. A display device (10) as claimed in any one of claims 1 to 4, and including motion compensation means employing motion estimation serving to enhance motion artefact reduction.

6. A display device (10) as claimed in any one of claims 1 to 5, wherein the sub-field converter (18) is arranged to alternate light output control patterns in predetermined units of the display.

7. A display device (10) as claimed in claim 6, wherein the pattern comprises a checker-board pattern.

8. A method of driving a display device (10) by means of a plurality of weighted and duplicated sub-fields, characterized by the step of weighting the sub-field in accordance with a ternary distribution of weights.

9. A method as claimed in claim 8, and employing symmetrical duplicated ternary weights.

10. A method as claimed in claim 8 or 9, wherein the ternary weights are distributed in a manner of increasing weighted value toward a central value or values.

11. A method as claimed in any one of claim 8, 9, or 10, wherein the highest sub-field weight is found in the centre of the ternary distribution.

12. A method as claimed in any one of claims 5 to 11, and including the step of duplicated sub-field addressing.

13. A method as claimed in claim 12, and including motion compensation employing motion estimation serving to enhance motion artefact reduction.

14. A method as claimed in claim 12 or 13, and including the step of alternating light output control patters in predetermined units of the display.

15. A method as claimed in claim 14, wherein the pattern comprises a checker board pattern.
